(19) United States
(12) Patent Application Publication
(10) Pub. No.: US 2025/0342979 A1
(43) Pub. Date: Nov. 6, 2025

(54) TECHNIQUES FOR PRODUCING ACTINIUM-225 AND RELATED SYSTEMS AND METHODS

(71) Applicant: Fusion Energy Solutions, Inc., Tempe, AZ (US)

(72) Inventor: Ian Horvath, Phoenix, AZ (US)

(73) Assignee: Fusion Energy Solutions, Inc., Tempe, AZ (US)

(21) Appl. No.: 18/925,649

(22) Filed: Oct. 24, 2024

Related U.S. Application Data
(60) Provisional application No. 63/642,908, filed on May 6, 2024.

(51) Int. Cl. G21G 1/02; G21G 1/00

(52) U.S. Cl. CPC G21G 1/02; G21G 1/001; G21G 2001/0089

(57) ABSTRACT

Techniques are described for producing actinium-225 by arranging a converter material at least partially around a target material, where the target material includes radium-226. The converter material comprises a compound of lithium and hydrogen at least partially enriched with lithium-6 and deuterium, and is configured to convert thermal neutrons to fast neutrons, which are then incident on the radium-226. If the fast neutrons have a kinetic energy of at least 6.4 MeV, they will initiate a (n,2n) reaction that converts radium-226 into radium-225, which then decays into actinium-225. The process can desirably be performed within an environment rich in thermal neutrons, such as within a fission reactor.

### CROSS-REFERENCE TO RELATED APPLICATIONS

The present application claims the benefit under 35 U.S.C. § 119(e) of U.S. Provisional Patent Application No. 63/642,908, filed May 6, 2024, titled “Techniques for Producing Actinium-225 and Related Systems and Methods,” which is hereby incorporated by reference in its entirety.

### BACKGROUND

Actinium-225 is an isotope of actinium that shows great promise in medical applications due to its favorable decay properties. In particular, decay of actinium-225 (Ac-225) produces short-range, high energy radiation suitable for use in targeted alpha therapy. Its 10-day half-life is long enough to allow for treatment but short enough that it rapidly decays in the body, the decay products of Ac-225 are safer than those of other isotopes, and each decay of Ac-225 produces four high energy alpha particles, making it a potent source. The current supply of Ac-225 is small, however, and there have been no successful large scale production efforts, which severely limits its use in treatment.

### SUMMARY

According to some aspects, a capsule configured to be inserted into a fission reactor is provided, the capsule comprising a target material comprising radium-226, and a converter material at least partially surrounding the target material, the converter material comprising a compound of lithium and hydrogen at least partially enriched with lithium-6 and deuterium.

According to some aspects, a method of obtaining actinium-225 is provided, the method comprising inserting a capsule into a fission reactor, the capsule comprising a target material comprising radium-226 and a converter material at least partially surrounding the target material, the converter material comprising a compound of lithium and hydrogen at least partially enriched with lithium-6 and deuterium, leaving the capsule in the fission reactor for a first time period, removing the capsule from the fission reactor, extracting the target material from the capsule, and milking the target material for actinium.

The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a schematic of a process of producing Ac-225, according to some embodiments;

FIG. 2 is a schematic of a system in which aspects of the present disclosure may be practiced, according to some embodiments;

FIG. 3 is a cross-sectional view of a capsule comprising a converter material and a target material, according to some embodiments;

FIG. 4 is a cross-sectional view of a capsule comprising a converter material and a target material, according to some embodiments;

FIG. 5 is a flowchart of a method of producing actinium-225, according to some embodiments; and

FIG. 6 is a chart depicting simulated results of performing method 500 compared to conventional approaches, according to some embodiments.

### DETAILED DESCRIPTION

As described above, Ac-225 shows great promise as a cancer treatment for numerous reasons, but it does not occur naturally and has historically been difficult to produce pure samples in all but small volumes. For instance, for many years the primary source of Ac-225 has been through decay of thorium-229 (Th-229), which decays to radium-225 (Ra-225) via alpha emission, which then beta decays to Ac-225. However, the decay of Th-229 is relatively slow (half-life of 7340 years), so this technique produces a low yield of Ac-225.

Alternatively, Ac-225 can be produced through various high energy particle accelerator techniques, including spallation of thorium-232, by directing an electron beam onto a gamma converter, or directing cyclotron protons onto radium-226 (Ra-226). These techniques can produce more Ac-225 than thorium decay, although they are energetically expensive and require a lot of chemical post-processing, since the reactions create other products that must be separated from the Ac-225. In particular, these reactions create the much longer-lived isotope actinium-227 (Ac-227), along with the shorter lived isotopes actinium-224 and actinium-226, which cannot be chemically separated from Ac-225.

The inventors have recognized and appreciated techniques for producing Ac-225 by arranging a converter material at least partially around a target material, where the target material includes atoms of Ra-226. The converter material is configured to convert thermal neutrons to fast neutrons, which are then incident on the Ra-226 atoms. If the fast neutrons have a kinetic energy of at least 6.4 MeV, they will initiate a (n,2n) reaction that converts an Ra-226 into Ra-225, which then decays into Ac-225. The process can desirably be performed within an environment rich in thermal neutrons, such as within a fission reactor. Neutrons, including both thermal neutrons and some fast neutrons, are produced naturally in a fission reactor, yet the majority of the neutrons in that environment do not have sufficient energy to produce Ra-225 from Ra-226. The converter material allows for conversion of thermal neutrons into fast neutrons, thereby increasing the rate at which Ra-226 may be converted to Ra-225.

According to some embodiments, the converter material may comprise lithium hydride (LiH). Preferably, the LiH is at least partially enriched with lithium-6 (Li-6) and/or with deuterium (H-2). Ambient thermal neutrons can cause fission of Li-6, which produces a triton (the nucleus of a tritium atom, ³H) in addition to an atom of helium-4. The triton can in turn undergo fusion with a deuterium atom to form the compound helium-5 nucleus, which quickly decays to helium-4 and a neutron with a kinetic energy of 14.1 MeV. Accordingly, thermal neutrons in a Li-6 and deuterium rich environment can readily produce neutrons with a kinetic energy that is far above the 6.4 MeV energy required to convert Ra-226 to Ra-225. In this manner, a converter material that comprises at least some Li-6 and deuterium can convert thermal neutrons to fast neutrons.

According to some embodiments, the converter material may be arranged to fully surround a target material comprising Ra-226. As referred to herein, a target material comprising Ra-226 refers to any material that includes atoms and/or ions of Ra-226, whether in a pure form, as a compound, in solution, as a suspension, as an emulsion, and/or in any other suitable form. The techniques described herein relate to neutrons being incident on a Ra-226 nucleus, and the particular form in which the Ra-226 nuclei are provided as a target material is not limited. Similarly, references to the converter material comprising Li-6, deuterium and/or any other isotope should not be construed as limiting the particular form of a material in which these isotopes may be found.

According to some embodiments, the converter material and target material may be arranged in a vessel with the target material arranged interior to the converter material. For example, the converter material may partially or fully envelop the target material, and the converter material and target material may be arranged within a capsule formed from a metal or other suitable material. Preferably, the capsule is formed from material that can be placed within a fission reactor without meaningfully affecting the operation of the reactor, and moreover does not meaningfully block thermal neutrons from passing into the capsule and interacting with the converter material. In addition, it may be preferable that the capsule is formed from material that has low levels of activation when exposed to the neutron flux found in a fission reactor.

According to some embodiments, the target material may be, or may comprise, a compound of Ra-226, such as radium chloride or radium nitrate. Since radium is a reactive element, it may be preferable to utilize a compound of Ra-226 as the target material so that the target material is less reactive. In some embodiments, the target material may be, or may comprise, a solid compound of Ra-226, such as solid radium chloride and/or solid radium nitrate. In some embodiments, the target material may be, or may comprise, a solution of a compound of Ra-226, such as a solution of radium chloride and/or radium nitrate, such as an aqueous solution of radium chloride and/or an aqueous solution of radium nitrate.

Following below are more detailed descriptions of various concepts related to, and embodiments of, techniques for producing Ac-225. It should be appreciated that various aspects described herein may be implemented in any of numerous ways. Examples of specific implementations are provided herein for illustrative purposes only. In addition, the various aspects described in the embodiments below may be used alone or in any combination, and are not limited to the combinations explicitly described herein.

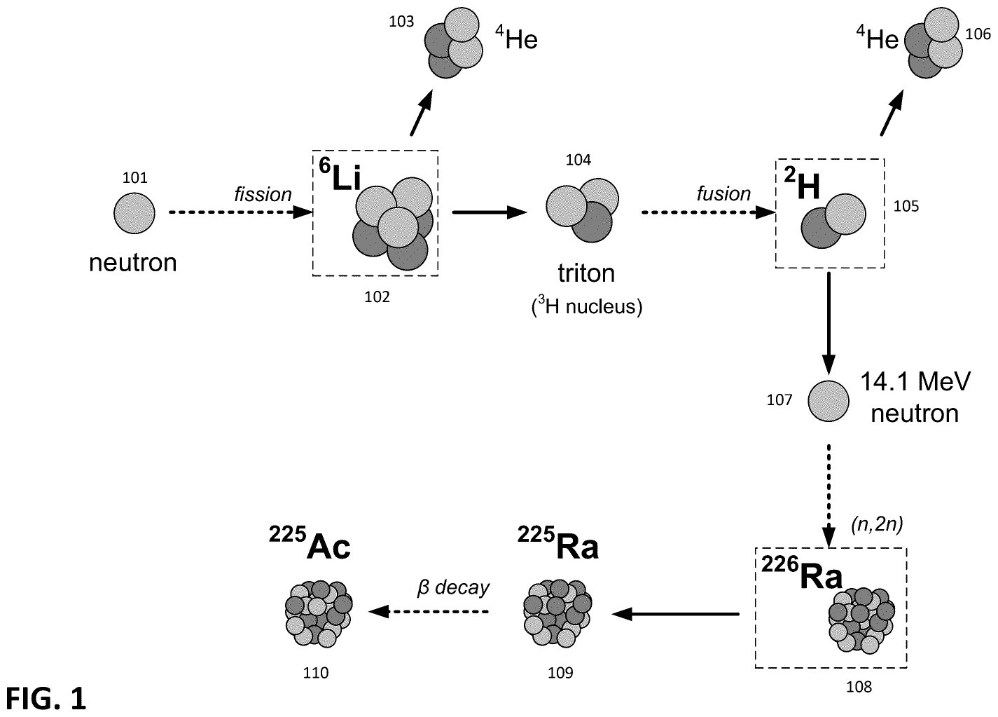

FIG. 1 is a schematic of a process of producing Ac-225, according to some embodiments. In the example of FIG. 1, a neutron 101 initiates a series of reactions that involve atoms of Li-6, deuterium and Ra-226, which are shown in FIG. 1 with dashed boxes. When performing techniques to produce Ac-225 as described herein, atoms of Li-6, deuterium and Ra-226 may generally be present within a volume, such as within a vessel containing a converter material (which includes both Li-6 and deuterium) and containing a target material comprising Ra-226. As described above, one illustrative way to implement such a combination of materials is with a converter material comprising enriched lithium hydride such that a significant amount of the lithium atoms are Li-6 and a significant amount of the hydrogen atoms are deuterium, and a target material comprising Ra-226.

In the example of FIG. 1, a neutron (101) is initially incident on an atom of Li-6 (102) within the converter material. The neutron (101) may cause fission of the Li-6 atom, depending on the kinetic energy of the neutron. In particular, the lower the energy of the neutron 101, the more likely it is to produce fission of the Li-6 atom. As such, thermal neutrons are more effective than fast neutrons for initiating fission of Li-6. The fission of Li-6 produces an atom of He-4 (103) and a tritium nucleus, also known as a triton (104), which when produced in this way typically has a kinetic energy of just under 3 MeV. If the triton is incident on a deuterium atom (which may occur in a short distance in a compound such as lithium hydride), it may fuse with the deuterium (105), which produces an atom of He-4 (106) and a neutron (107) that has a kinetic energy of 14.1 MeV. The kinetic energy of this neutron is more than the 6.4 MeV necessary to initiate a (n,2n) reaction that converts Ra-226 into Ra-225.

Accordingly, so long as the neutron 107 propagates to an atom of Ra-226 (108) with more than 6.4 MeV (which should generally happen if the Ra-226 is close by, even if the neutron's kinetic energy is attenuated through collisions between being produced and reacting with the Ra-226), this neutron (107) will lead to the production of Ra-225 (109). Ra-225 decays to Ac-225 (110) with a half-life of about 15 days.

It has been recognized by the inventors that the process of FIG. 1 may produce a significant amount of Ac-225 compared with prior approaches. In particular, while neutrons having a kinetic energy of 6.4 MeV or higher can be produced in a particle accelerator or in a fission reactor, the process of FIG. 1 can take advantage of the thermal neutron spectrum already available in a fission reactor to more readily produce Ra-225. For instance, Ra-226 could be placed in a fission reactor with a neutron shield around it to filter out the thermal neutrons so that only fast neutrons with sufficient energy to produce Ra-225 from Ra-226 are transmitted through the shield. However, the rate of Ra-226 production using this approach is typically much less than the process of FIG. 1, which instead converts at least part of the thermal neutron spectrum into fast neutrons, as described further below.

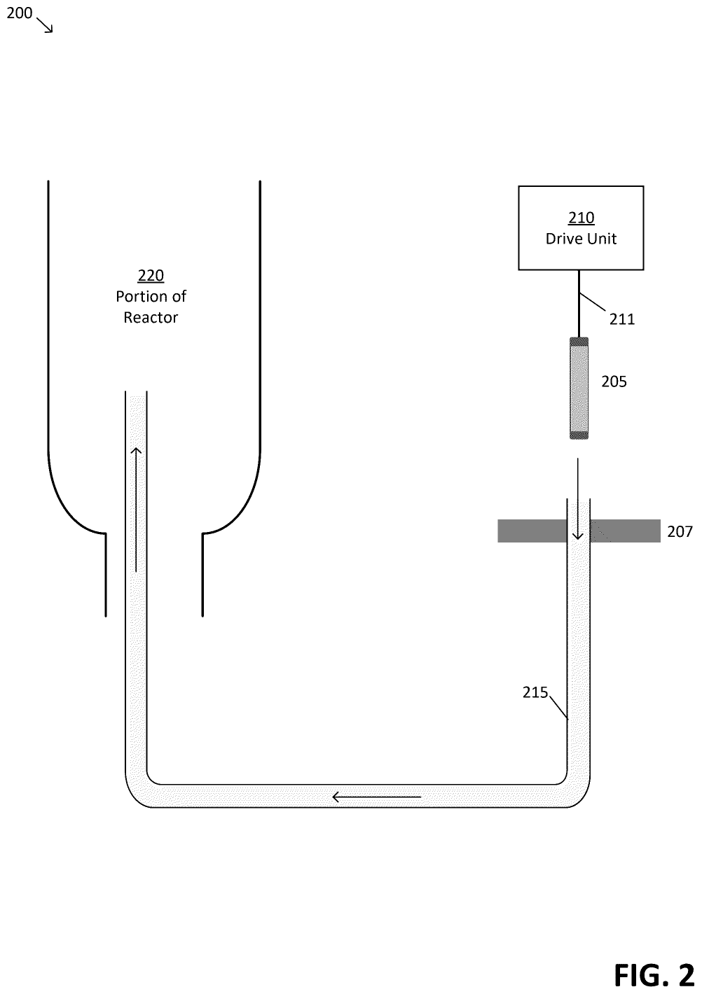

FIG. 2 is a schematic of a system in which aspects of the present disclosure may be practiced, according to some embodiments. In the example of FIG. 2, system 200 includes a portion of a fission reactor 220 and a guide tube 215 that allows for insertion of a capsule 205 into the reactor. The guide tube 215 may guide the capsule 205 into the reactor by allowing the capsule to be passed through the seal table 207 and through the guide tube into the reactor. Motion of the capsule 205 is produced by a drive unit 210 coupled to the capsule 205 via cable 211. The capsule 205 may be inserted through the seal table, which separates atmospheric pressure outside the guide tube and reactor from inside the guide tube and reactor where the pressure may be over 2000 psi. The capsule may be inserted directly into the guide tube through a thimble or port, or may be inserted into a vessel that is directed into the reactor as described above.

According to some embodiments, the guide tube 215 may be a flux thimble guide tube, also sometimes called a thimble tube, that is also used for inserting measurement probes and other devices used routinely in commercial fission reactors. However, it may be appreciated that this process of inserting a capsule into a reactor may be different at a research reactor versus a commercial reactor, and as such the example of FIG. 2 may not apply to all implementations.

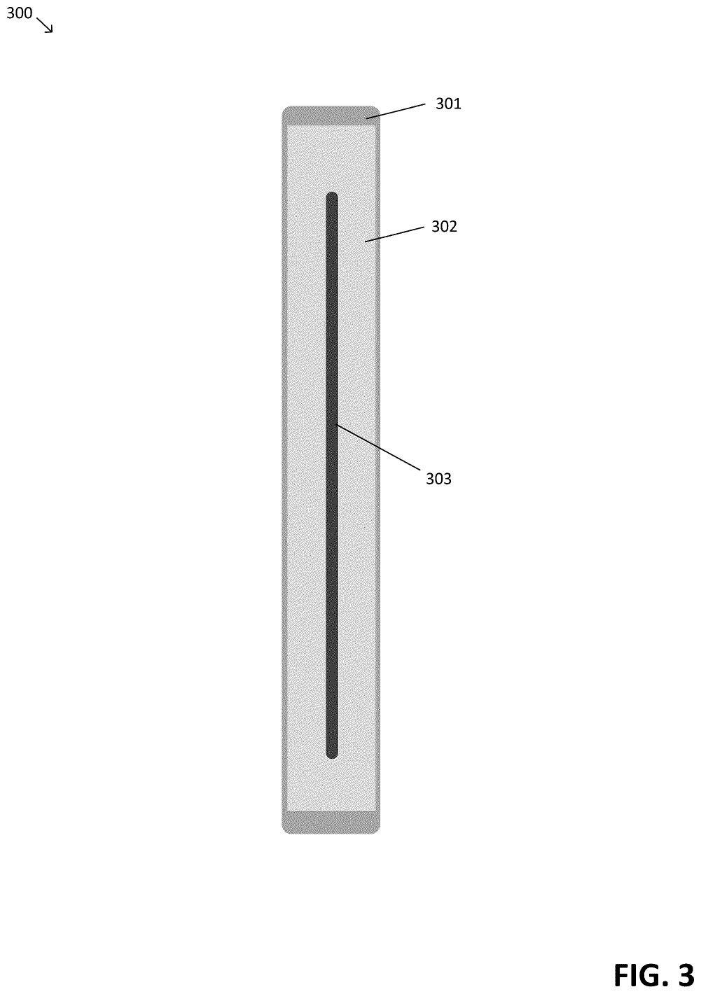

FIG. 3 is a cross-sectional view of a capsule comprising a converter material and a target material, according to some embodiments. The capsule 300 may for instance be used as capsule 205 in the example of FIG. 2 and inserted into a reactor as described above in relation to FIG. 2. In the example of FIG. 3, the capsule 300 comprises a converter material 302, a target material 303, both of which are encapsulated by a housing 301. In some embodiments, the converter material 302 and target material 303 may be hermetically sealed within the housing 301.

According to some embodiments, housing 301 may be a cylinder, or may be substantially cylindrical. In such cases, the cross-sectional view shown in FIG. 3 may be representative of all cross-sections along the same axis, such that the capsule has rotational symmetry around its long axis. The housing of the capsule may have rounded edges as shown in the drawing, yet the capsule may still be considered to be cylindrical for the purposes of this disclosure.

According to some embodiments, housing 301 may be formed from, or may comprise, a metal or metal alloy. In some embodiments, housing 301 is formed from titanium, comprises titanium, or consists essentially of titanium. As used herein, the term “capsule” refers to any encapsulated vessel in which a converter material and a target material are arranged, and the term is not intended to suggest any particular size or shape of this vessel. As such, while embodiments depicted in the drawings include a cylindrical capsule, it will be appreciated that the capsule may in general have any suitable size and/or shape so long as the capsule is suitable for insertion into an environment containing neutrons sufficient to initiate the process depicted in FIG. 1.

According to some embodiments, housing 301 may include multiple elements, such as metal elements, joined together via a process such as welding, brazing, crimping, pressing, threading and/or soldering. In some cases, for instance, the converter material 302 and target material 303 may be inserted into an open end of a vessel, then a plug or cap welded to the vessel to produce housing 301 and capsule 300 as shown in FIG. 3. As such, in some cases a welding seam may be present on the exterior surface of housing 301, although in general it may be desirable to make this welding seam as invisible as possible to ensure the capsule can be inserted and removed from a reactor without snagging or otherwise limiting movement of the capsule during its motion.

In the example of FIG. 3, the converter material 302 may include any substance or substances that contain both Li-6 and deuterium. As described above, the ingredients for the process shown in FIG. 1 to produce fast neutrons from thermal neutrons include Li-6 and deuterium nuclei. As such, any converter material that includes both of these isotopes in some form may be suitable for use as the converter material 302, though it is usually desirable that the concentrations of Li-6 and deuterium be as high as possible to facilitate as much thermal to fast neutron conversion as possible. Lithium has a natural abundance of Li-6 of about 5% (with the remainder being lithium-7).

In some embodiments, the converter material 302 comprises a lithium compound having a Li-6 isotopic enrichment (the fraction of the lithium in the compound that is Li-6) that is greater than or equal to 5%, 10%, 20%, 30%, 40%, 50%, 60%, 70%, 75%, 80%, 85%, 90%, 95%, 98%, 99%, or 99.5%. In some embodiments, the converter material 302 comprises a lithium compound having a Li-6 isotopic enrichment that is less than or equal to 100%, 99.5%, 99%, 98%, 95%, 90%, 85%, 80%, 70%, 60%, 50%, 40%, 30%, 20%, or 10%. Any suitable combinations of the above-referenced ranges are also possible (e.g., the converter material 302 comprises a lithium compound having a Li-6 isotopic enrichment of greater than or equal to 90% and less than or equal to 95%).

In some embodiments, the converter material 302 may comprise a lithium compound with an isotopic enrichment close to the natural abundance of Li-6, namely around 5%. The inventors have recognized that due to the high thermal neutron absorption rate of lithium, it may not be necessary to include high levels of Li-6 in a lithium compound in the converter material. As indicated by the above ranges, for instance, the converter material 302 may comprise a lithium compound having a Li-6 isotopic enrichment that is greater than or equal to 10% and less than or equal to 20%.

In some embodiments, the converter material 302 comprises a hydrogen compound having a deuterium isotopic enrichment (the fraction of the hydrogen in the compound that is deuterium) that is greater than or equal to 75%, 80%, 85%, 90%, 95%, 98%, 99%, or 99.5%. In some embodiments, the converter material 302 comprises a hydrogen compound having a deuterium isotopic enrichment that is less than or equal to 100%, 99.5%, 99%, 98%, 95%, 90%, 85% or 80%. Any suitable combinations of the above-referenced ranges are also possible (e.g., the converter material 302 comprises a hydrogen compound having a deuterium isotopic enrichment of greater than or equal to 95% and less than or equal to 99%).

In some embodiments, the converter material 302 comprises a compound of lithium and hydrogen, such as lithium hydride or lithium hydroxide, in which the isotopic enrichment of Li-6 and deuterium may have any suitable combinations of the above-referenced ranges for lithium compounds and hydrogen compounds. For instance, the converter material 302 may comprise lithium hydride (LiH) having a Li-6 isotopic enrichment of greater than or equal to 98% and less than or equal to 100%, and having a deuterium isotopic enrichment of greater than or equal to 95% and less than or equal to 100%. Any other combinations of the above ranges are also possible. In some embodiments, the converter material may comprise, may consist essentially of, or may consist of, lithium-6 deuteride.

In some embodiments, the converter material 302 comprises a compound of lithium and hydrogen isotopically enriched with Li-6 and deuterium, and also comprises one or more additional elements or compounds that may further enhance the rate of the process shown in FIG. 1. Such elements or compounds may include, but are not limited to, helium, beryllium, compounds of beryllium, boron, compounds of boron, carbon, compounds of carbon, nitrogen, compounds of nitrogen, oxygen, compounds of oxygen, fluoride, compounds of fluoride, or combinations thereof.

In the example of FIG. 3, the target material 303 may include any substance or substances that contain Ra-226. As described above, the ingredients for the process shown in FIG. 1 to produce fast neutrons from thermal neutrons include Ra-226 nuclei (in addition to nuclei of Li-6 and deuterium). As such, any target material that includes Ra-226 nuclei may be suitable for use as the target material 303, though it is desirable that the concentration of Ra-226 be as high as possible to facilitate as much thermal to fast neutron conversion as possible.

In some embodiments, the target material 303 comprises radium or a radium compound having a Ra-226 isotopic enrichment (the fraction of radium in the compound that is Ra-226) that is greater than or equal to 75%, 80%, 85%, 90%, 95%, 98%, 99%, or 99.5%. In some embodiments, the target material 303 comprises radium or a radium compound having a Ra-226 isotopic enrichment that is less than or equal to 100%, 99.5%, 99%, 98%, 95%, 90%, 85% or 80%. Any suitable combinations of the above-referenced ranges are also possible (e.g., the target material 303 comprises radium or a radium compound having a Ra-226 isotopic enrichment of greater than or equal to 98% and less than or equal to 100%).

In some embodiments, the target material 303 comprises one or more radium compounds such as, but not limited to, radium chloride, radium nitride, radium nitrate, radium hydroxide, radium fluoride, radium bromide, radium carbonate, radium sulfate, radium oxide, radium fluoride or combinations thereof. Any one or more of such radium compounds may be included in the target material 303, and each may be isotopically enriched with Ra-226 according to the above levels of Ra-226 isotopic enrichment. For instance, the target material 303 may comprise radium chloride having a Ra-226 isotopic enrichment of greater than or equal to 98% and less than or equal to 100%, with any other suitable combinations of the above-referenced ranges being also possible. As described above, in some cases a radium compound may be provided as a solution. As one example, the target material 303 may comprise an aqueous solution of radium chloride, wherein the radium chloride in the solution has a Ra-226 isotopic enrichment of greater than or equal to 98% and less than or equal to 100%, with any other suitable combinations of the above-referenced ranges being also possible.

References here to an “isotopically enriched” material are not intended to imply that isotopic separation of isotopes necessarily be performed to produce that material, although in some cases it may. Rather, this term along with references to “isotopic enrichment” of a material are intended only to refer to the amount of particular isotopes in the material, not how that material was produced. For instance, extraction of deuterium from sea water may comprise isotopic separation. Some methods of extracting Ra-226 may also comprise isotopic separation. However, in some cases Ra-226 may be obtained from natural sources of radium that include both Ra-226 and Ra-228. Since Ra-228 has a much shorter half-life than Ra-226, the passage of time may produce a natural source much more abundant in Ra-226 than Ra-228 without any isotopic separation being performed.

An amount of isotopic enrichment of the converter material 302 or target material 303 according to any of the above ranges may for instance be measured via a method such as nuclear magnetic resonance (NMR) or mass spectrometry.

According to some embodiments, the target material 303 is housed within a vessel that is arranged within the converter material 302. In some cases, the vessel may comprise quartz (SiO₂), soda lime, and/or a borosilicate glass. In some embodiments, for instance, the target material 303 may be a solution of a radium compound held within a glass vial. A vessel (e.g., vial or tube) containing the target material may have a thickness of between 10 μm and 30 μm, such as 20 μm (e.g., a borosilicate glass tube).

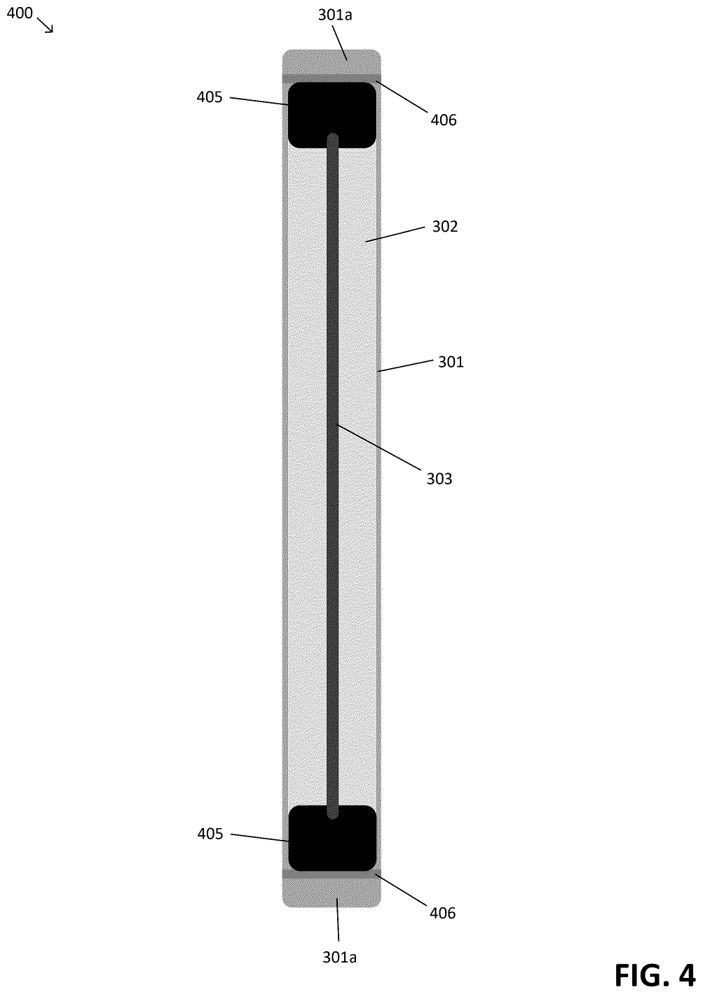

FIG. 4 is a cross-sectional view of a capsule comprising a converter material and a target material, according to some embodiments. The capsule 400 may for instance be used as capsule 205 in the example of FIG. 2 and inserted into a reactor as described above in relation to FIG. 2. In the example of FIG. 4, the capsule 400 comprises a converter material 302, a target material 303, both of which are encapsulated by housing 301. In addition, the capsule 400 comprises plugs 405 and seams 406.

Capsule 400 may be implemented according to any of the embodiments described above in relation to capsule 300 with respect to housing 301, converter material 302 and target material 303. Capsule 400 differs from capsule 300 in that capsule 400 includes the plugs 405 and seams 406.

In the example of FIG. 4, seams 406 are seams produced by welding or some other technique for joining parts such as brazing, soldering, crimping, pressing or threading. As described above, the housing 301 may include multiple elements, such as metal elements, joined together. In the case of welding, for instance, the seams 406 may be produced by welding the caps 301a to a tube to form the housing 301. The converter material 302, target material 303 and plugs 405 may be inserted into the partially formed housing prior to welding either or both of the caps 301a. The plugs 405 may generally be provided in any interior side of a capsule.

According to some embodiments, plugs 405 may comprise, may be formed from, or may consist essentially of, carbon (e.g., graphite). In some embodiments, the plugs 405 may comprise graphite, beryllium, lithium-7, boron-11, one or more deuterium-enriched hydrocarbons, diamond, one or more metals, or combinations thereof.

The plugs 405 may provide one or more of the following desirable features. First, the plugs may dissipate heat during the above-described processes for attaching the caps 301a to other parts of the housing 301, thereby protecting the target material, which may be volatile, from excess heat. Additionally, or alternatively, the plugs 405 may comprise a recess (such as a hole) in their center to allow the target material to be centered in the housing 301, as shown by the target material extending into the plugs in FIG. 4. In some embodiments, the capsule 400 may comprise a solution of a compound of radium held within a glass vial, wherein ends of the glass vial are inserted into and held by a recess in a respective plug 405. Either or both of the above advantages provided by the plugs 405 may be realized, as it is not necessary that plugs be included and also that the target material extends into the plugs. In some cases, the plugs may be used for heat dissipation alone and the target material may be completely surrounded by the converter material as shown in FIG. 3.

In some embodiments, it may also be the case that for certain materials, the plugs may modestly increase the amount of thermal neutrons incident on the target material 303. For example, carbon plugs may attenuate some higher energy neutrons such that lower energy thermal neutrons are incident on the converter material, whereas but for the carbon plugs the incident neutrons would have a higher energy than thermal neutrons.

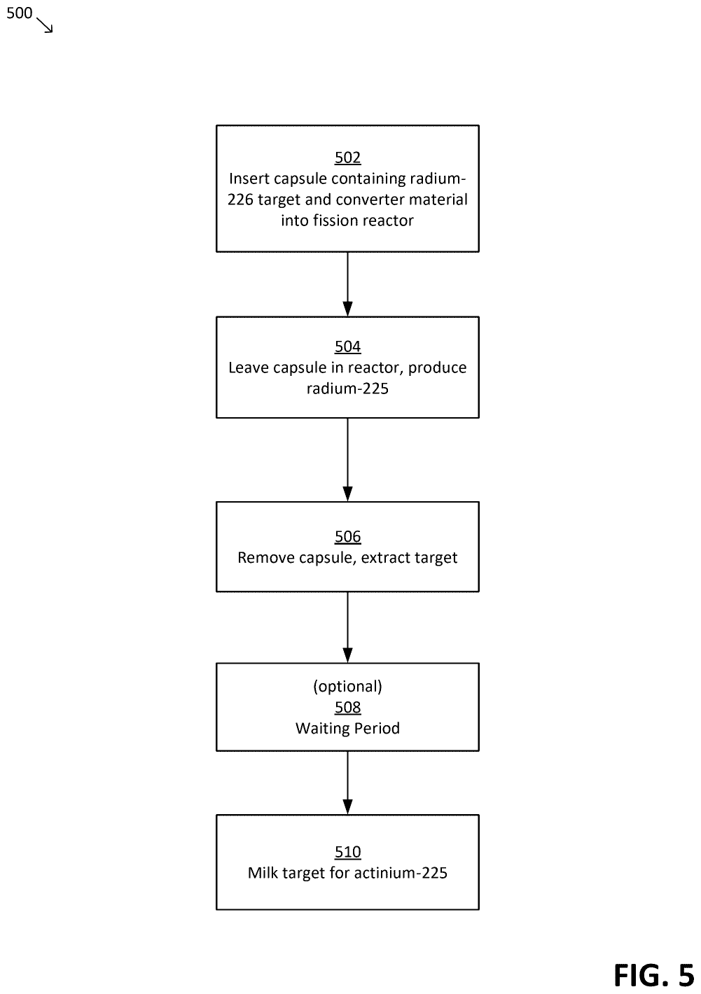

FIG. 5 is a flowchart of a method of producing actinium-225, according to some embodiments. Method 500 may be performed using any suitable capsule comprising a converter material comprising Li-6 and deuterium, and a target material comprising Ra-226, as described above. For instance, method 500 may be performed using capsule 300 or capsule 400, in addition to a suitable fission reactor or other environment comprising thermal neutrons.

Method 500 begins in act 502 in which a capsule comprising a converter material comprising Li-6 and deuterium, and a target material comprising Ra-226, is inserted into a fission reactor. A suitable process for inserting the capsule into a reactor is described above in relation to FIG. 2, although any suitable process may be used so long as the capsule is placed in a location where it will be bombarded with thermal neutrons.

In act 504, the capsule is left in the reactor for a period of time during which Ra-225 is produced in the target material as described in relation to FIG. 1. Other isotopes may also be produced within the capsule during this time, though a full discussion of these isotopes is outside the scope of this disclosure.

In some embodiments, the capsule may be left in the reactor for a time period greater than or equal to 5 days, 10 days, 15 days, 20 days or 25 days. In some embodiments, the capsule may be left in the reactor for a time period that is less than or equal to 30 days, 25 days, 20 days, 15 days, or 10 days. Any suitable combinations of the above-referenced ranges are also possible (e.g., the capsule may be left in the reactor for a time period of greater than or equal to 5 days and less than or equal to 10 days).

In act 506, the capsule is removed from the reactor and the target material is extracted from the capsule. In act 510, the target material is ‘milked’ for actinium, which is a process of chemically separating actinium from other elements within the target material.

Optionally, a waiting period may be performed in act 508 between acts 506 and 510 so that some undesirable isotopes produced in the target material in act 504 have a chance to decay a suitable amount before milking starts. One example is radium-227, which decays into actinium-227 via beta decay with a half-life of 42 minutes. Since actinium-227 and actinium-225 cannot be distinguished chemically, it may be advantageous to wait for several hours (e.g., seven or more hours) so that the vast majority of radium-227 produced in the target material decays into actinium-227. An initial actinium milking that will yield both actinium-225 and actinium-227 can then be performed and the products discarded (or used for some other application), ensuring that any subsequent actinium that is extracted during milking is pure, or highly pure, actinium-225.

After act 510 has been performed, if desired, the target material can be used in another iteration of method 500 by encapsulating it in a capsule with a converter material (either the same or different capsule and converter material) and returning to act 502.

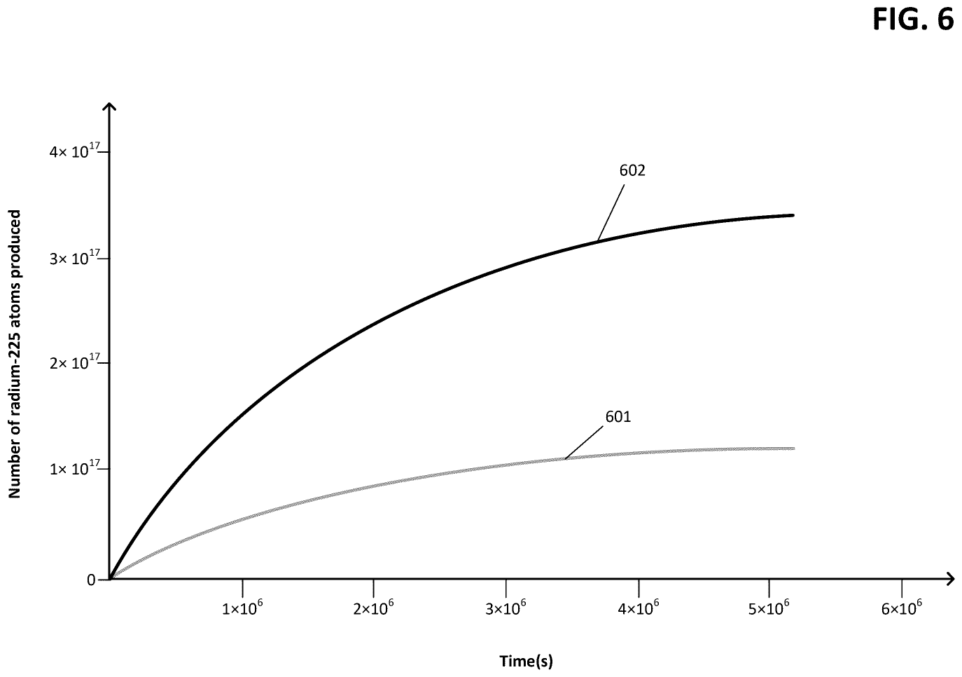

FIG. 6 is a chart depicting simulated results of performing method 500 compared to conventional approaches, according to some embodiments. In the example of FIG. 6, line 601 represents the number of Ra-225 atoms produced over time for a given target material sample using a conventional approach of producing Ra-225 via fast neutrons incident on Ra-226.

In contrast, line 602 represents the number or Ra-225 atoms produced over time using method 500 in which a capsule comprising a converter material comprising Li-6 and deuterium, and a target material comprising Ra-226, is inserted into a fission reactor. Lines 601 and 602 are normalized to the same initial target material. As shown in FIG. 6, the use of the converter material to convert thermal neutrons into fast neutrons produces a much higher yield of Ra-225 for a given Ra-226 target material under the same conditions.

Having thus described several aspects of at least one embodiment of this invention, it is to be appreciated that various alterations, modifications, and improvements will readily occur to those skilled in the art. For instance, aspects of the techniques described herein may be combined in any of the following ways:

According to some aspects, the techniques described herein relate to a capsule configured to be inserted into a fission reactor, the capsule including: a target material including radium-226; and a converter material at least partially surrounding the target material, the converter material including a compound of lithium and hydrogen at least partially enriched with lithium-6 and deuterium.

According to some aspects, the techniques described herein relate to a capsule, wherein the target material and the converter material are hermetically sealed within the capsule.

According to some aspects, the techniques described herein relate to a capsule, wherein the compound of lithium and hydrogen is lithium hydride (LiH).

According to some aspects, the techniques described herein relate to a capsule, wherein the capsule is a metal cylinder.

According to some aspects, the techniques described herein relate to a capsule, wherein the metal cylinder is a titanium cylinder.

According to some aspects, the techniques described herein relate to a capsule, wherein the target material is encapsulated within a glass vessel.

According to some aspects, the techniques described herein relate to a capsule, wherein the converter material fully surrounds the target material.

According to some aspects, the techniques described herein relate to a capsule, further including at least one carbon plug arranged between the converter material and an interior side of the capsule.

According to some aspects, the techniques described herein relate to a capsule, wherein the at least one carbon plug includes at least one hole in which a portion of the target material is arranged.

According to some aspects, the techniques described herein relate to a capsule, wherein the target material includes a radium compound at least partially enriched with radium-226.

According to some aspects, the techniques described herein relate to a capsule, wherein the radium compound is radium chloride.

According to some aspects, the techniques described herein relate to a capsule, wherein the radium compound consists essentially of radium-226 chloride.

According to some aspects, the techniques described herein relate to a capsule, wherein at least 95% of the radium in the radium compound is radium-226.

According to some aspects, the techniques described herein relate to a capsule, wherein at least 95% of the hydrogen in the compound of lithium and hydrogen is deuterium.

According to some aspects, the techniques described herein relate to a capsule, wherein at least 90% of the lithium in the compound of lithium and hydrogen is lithium-6.

According to some aspects, the techniques described herein relate to a capsule, wherein the compound of lithium and hydrogen consists essentially of lithium-6 deuteride.

According to some aspects, the techniques described herein relate to a method of obtaining actinium-225, the method including: inserting a capsule into a fission reactor, the capsule including a target material including radium-226 and a converter material at least partially surrounding the target material, the converter material including a compound of lithium and hydrogen at least partially enriched with lithium-6 and deuterium; leaving the capsule in the fission reactor for a first time period; removing the capsule from the fission reactor; extracting the target material from the capsule; and milking the target material for actinium.

According to some aspects, the techniques described herein relate to a method, wherein the first time period is at least 5 days.

According to some aspects, the techniques described herein relate to a method, further including waiting for at least 1 hour between extracting the target material from the capsule and milking the target material for actinium.

According to some aspects, the techniques described herein relate to a method, wherein milking the target material for actinium includes: a first milking period during which the target material is milked for actinium, thereby producing a first yield of actinium that includes actinium-225 and actinium-227; and a second milking period during which the target material is milked for actinium, thereby producing a second yield of actinium that consists essentially of actinium-225.

According to some aspects, the techniques described herein relate to a method, further including discarding the first yield of actinium.

According to some aspects, the techniques described herein relate to a method, wherein inserting the capsule into the fission reactor includes operating a drive unit to drive the capsule through a guide tube into the fission reactor.

According to some aspects, the techniques described herein relate to a method, wherein the target material and the converter material are hermetically sealed within the capsule.

According to some aspects, the techniques described herein relate to a method, wherein the compound of lithium and hydrogen is lithium hydride (LiH).

According to some aspects, the techniques described herein relate to a method, wherein the capsule is a metal cylinder.

According to some aspects, the techniques described herein relate to a method, wherein the metal cylinder is a titanium cylinder.

According to some aspects, the techniques described herein relate to a method, wherein the target material is encapsulated within a glass container.

According to some aspects, the techniques described herein relate to a method, wherein the converter material fully surrounds the target material.

According to some aspects, the techniques described herein relate to a method, further including at least one carbon plug arranged between the converter material and an interior side of the capsule.

According to some aspects, the techniques described herein relate to a method, wherein the at least one carbon plug includes at least one hole in which a portion of the target material is arranged.

According to some aspects, the techniques described herein relate to a method, wherein the target material includes a radium compound at least partially enriched with radium-226.

According to some aspects, the techniques described herein relate to a method, wherein the radium compound is radium chloride.

According to some aspects, the techniques described herein relate to a method, wherein the radium compound consists essentially of radium-226 chloride.

According to some aspects, the techniques described herein relate to a method, wherein at least 95% of the radium in the radium compound is radium-226.

According to some aspects, the techniques described herein relate to a method, wherein at least 95% of the hydrogen in the compound of lithium and hydrogen is deuterium.

According to some aspects, the techniques described herein relate to a method, wherein at least 90% of the lithium in the compound of lithium and hydrogen is lithium-6.

According to some aspects, the techniques described herein relate to a method, wherein the compound of lithium and hydrogen consists essentially of lithium-6 deuteride.

Such alterations, modifications, and improvements are intended to be part of this disclosure, and are intended to be within the spirit and scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

The terms “approximately” and “about” may be used to mean within ±20% of a target value in some embodiments, within ±10% of a target value in some embodiments, within ±5% of a target value in some embodiments, and yet within ±2% of a target value in some embodiments. The terms “approximately” and “about” may include the target value. The term “substantially equal” may be used to refer to values that are within ±20% of one another in some embodiments, within ±10% of one another in some embodiments, within ±5% of one another in some embodiments, and yet within ±2% of one another in some embodiments.

The term “substantially” may be used to refer to values that are within ±20% of a comparative measure in some embodiments, within ±10% in some embodiments, within ±5% in some embodiments, and yet within ±2% in some embodiments. For example, a first direction that is “substantially” perpendicular to a second direction may refer to a first direction that is within ±20% of making a 90° angle with the second direction in some embodiments, within ±10% of making a 90° angle with the second direction in some embodiments, within ±5% of making a 90° angle with the second direction in some embodiments, and yet within ±2% of making a 90° angle with the second direction in some embodiments.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A capsule configured to be inserted into a fission reactor, the capsule comprising:
a target material comprising radium-226; and
a converter material at least partially surrounding the target material, the converter material comprising a compound of lithium and hydrogen at least partially enriched with lithium-6 and deuterium.

2. The capsule of claim 1, wherein the target material and the converter material are hermetically sealed within the capsule.

3. The capsule of claim 1, wherein the compound of lithium and hydrogen is lithium hydride (LiH).

4. The capsule of claim 1, wherein the capsule is a metal cylinder.

5. The capsule of claim 1, wherein the target material is encapsulated within a glass vessel.

6. The capsule of claim 1, further comprising at least one carbon plug arranged between the converter material and an interior side of the capsule.

7. The capsule of claim 1, wherein the target material comprises a radium compound at least partially enriched with radium-226.

8. The capsule of claim 7, wherein the radium compound is radium chloride.

9. The capsule of claim 7, wherein at least 95% of the radium in the radium compound is radium-226.

10. The capsule of claim 1, wherein at least 95% of the hydrogen in the compound of lithium and hydrogen is deuterium.

11. A method of obtaining actinium-225, the method comprising:
inserting a capsule into a fission reactor, the capsule comprising a target material comprising radium-226 and a converter material at least partially surrounding the target material, the converter material comprising a compound of lithium and hydrogen at least partially enriched with lithium-6 and deuterium;
leaving the capsule in the fission reactor for a first time period;
removing the capsule from the fission reactor;
extracting the target material from the capsule; and
milking the target material for actinium.

12. The method of claim 11, wherein the first time period is at least 5 days.

13. The method of claim 11, further comprising waiting for at least 1 hour between extracting the target material from the capsule and milking the target material for actinium.

14. The method of claim 12, wherein milking the target material for actinium comprises:
a first milking period during which the target material is milked for actinium, thereby producing a first yield of actinium that includes actinium-225 and actinium-227; and
a second milking period during which the target material is milked for actinium, thereby producing a second yield of actinium that consists essentially of actinium-225.

15. The method of claim 11, wherein inserting the capsule into the fission reactor comprises operating a drive unit to drive the capsule through a guide tube into the fission reactor.

16. The method of claim 11, wherein the target material and the converter material are hermetically sealed within the capsule.

17. The method of claim 11, wherein the capsule is a metal cylinder.

18. The method of claim 11, wherein the target material comprises a radium compound at least partially enriched with radium-226.

19. The method of claim 18, wherein the radium compound is radium chloride.

20. The method of claim 18, wherein at least 95% of the radium in the radium compound is radium-226.
